(19) United States
(12) Patent Application Publication
(10) Pub. No.: US 2006/0010387 A1
(43) Pub. Date: Jan. 12, 2006

(54) Projection apparatus with support for media content on portable storage devices

(76) Inventor: Jorell A. Olson, Portland, OR (US)

Correspondence Address: SCHWABE, WILLIAMSON & WYATT, P.C., PACWEST CENTER, SUITE 1900, 1211 SW FIFTH AVENUE, PORTLAND, OR, 97204, US

(21) Appl. No.: 10/903,972

(22) Filed: Jul. 29, 2004

Related U.S. Application Data
(60) Provisional application No. 60/586,362, filed on Jul. 7, 2004.

(51) Int. Cl. G06F 3/00; G06F 17/00

(52) U.S. Cl. 715/730; 715/743

(57) ABSTRACT

A projection apparatus equipped to provide direct support for media contents stored in a portable storage device, and methods practiced thereon, are described herein.

### RELATED APPLICATION

The non-provisional application claims the benefit/priority of provisional application No. 60/586,362, entitled “Projection Apparatus with Support for Media Content on Portable Media Storage Devices, filed Jul. 7, 2004. The specification of said '362 provisional application is hereby fully incorporated by reference.

### TECHNICAL FIELD

The present invention relates generally to the field of image projection.

### BACKGROUND

Before the digital age, images, such as photographs, are often viewed through the use of slides and slide projectors, whereas, images, such as text and/or graphic documents, are often viewed through the use of foils (transparencies) and foil (transparency) projectors. With the advent of the digital age, in particular, with the ubiquitous availability of laptop computers and digital projectors, often, photographs and presentations are viewed through the use of these devices. The images would be rendered by the laptop computers, and projected by the digital projectors, with the laptop computers providing the images to the digital projectors in the form of image signals. These advances were particularly appreciated by the professionals who have to present in conferences and/or at customer/client sites. The presentations are readily available on the laptop computers, which are typically traveled with the professionals anyway. The only support they would need from the conference organizer or the customer/client is the digital projector.

Recently, advances in storage technology have dramatically reduced the cost as well as the form factors of storage devices. Solid state portable storage devices in the form of compact disk and the like are widely available, at increasing capacity and low cost. Moreover, they are plug and play, e.g. through popular standard compliant connectors, such as universal serial bus (USB) connectors. However, the benefit of the technology still yet to be fully realized for image projection, especially for the professionals who have to present in conferences and/or customer/client sites. They still have to travel with their laptop computers, or one would have to be provided by the “host” (i.e. the conference organizer, the customer/client).

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a block diagram view of the projection apparatus of the present invention, in accordance with various embodiments;

FIG. 2 illustrates the controller of FIG. 1 in further detail, in accordance with various embodiments;

FIG. 3 is a flow chart of selected operations of the controller of FIG. 1, in accordance with various embodiments; and

FIGS. 4a-4b illustrate two example projections for facilitating selection of a media content type and a media content of a media content type, in accordance with various embodiments.

### DETAILED DESCRIPTION OF ILLUSTRATIVE EMBODIMENTS

Illustrative embodiments of the present invention include but are not limited to projection apparatus equipped with direct support for media content stored in a portable storage device, and methods practiced thereon.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising”, “having”, and “including” are synonymous, unless the context dictates otherwise.

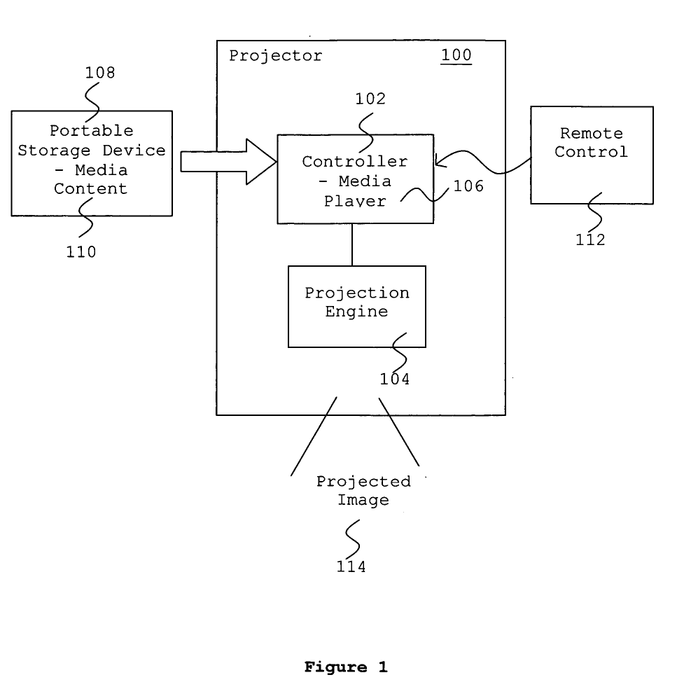

FIG. 1 illustrates a block diagram view of a projection apparatus equipped with direct support for media content stored in a portable storage device, in accordance with various embodiments. As illustrated, projector 100 includes controller 102 and projection engine 104 coupled to each other. As will be described in more detail below, controller 102 is endowed with features to enable projector 100 to provide direct support for the projection of media content 110 on a portable storage device 108. For the purpose of this application, the term “direct support” refers to the fact that the media content 110 stored on portable storage device 108 may be projected by projector 100 without the further provision of another rendering device, such as a laptop computer in the prior art.

As illustrated, controller 102 is endowed with one or more media player 106 equipped to support media content of one or more media types. For ease of understanding, one media player 106 is illustrated. In various embodiments, the one or more media player 106 support rendering or playing of media content of multiple media types. In particular, in various embodiments, one or more media players 106 support media content in at least the formats of a bitmap type, a JPEG/JPG type, a PCX type, a GIF type, and a TIF type. In alternate embodiments, other data formats may be supported in addition to the enumerated formats or in lieu of one or more of the enumerated formats. [JPEG=Joint Photographs Expert Group, PCX=PC Paintbrush Format; GIF=Graphics Interchange Format, and TIF=Tagged Image File Format.]

As will be described in more detail below, in various embodiments, portable storage device 108 is designed to mate with a standard compliant plug-and-play connector, and projector 100 is equipped with the plug-and-play connector, and corresponding software support, if any, for media content 110 to be accessed on attachment of portable storage device 108 to projector 100. In various embodiments, portable storage device 108 is a non-volatile solid state storage device. In particular, it is designed to be mated with a universal serial bus (USB) connector. Accordingly, projector 100 is complementarily equipped, that is with at least one USB connector, host controller, USB device driver and so forth.

In alternate embodiments, portable storage device 108 may be a Memory Stick, a Memory Stick Pro, a Solid State Floppy Disk Card (SSFDC), a Multi Media Card (MMC), a Secured Digital (SD™ Card), a CompactFlash™, or a xD-Picture Card™, instead.

Further, for the embodiment, projector 100 is equipped to enable a user to control its operation through remote control 112. In various embodiments, remote control 112 provides the user controls to projector 100 in the form of infrared (IR) signals. Accordingly, projector 100 is equipped with the appropriate IR receiver. In alternate embodiments, other forms of controls, including wired based controls may be provided and employed instead.

Projection engine 104 is employed to project images of media content, including media content 110 read off an attached one of the portable storage devices 108. Projection engine 104 includes conventional optical and electro-opto elements, such as light source(s), lens, light tunnels, color wheels, projection valves, and so forth, electro-optically coupled to each other. Accordingly, projection engine 104 represents a broad range of the element known in the art or to be designed, as long as controller 102 may be equipped with an appropriate interface to control it. An example of projection engine 104 is anyone of the various projection engines used in the projectors available from InFocus Corp of Wilsonville, Oreg.

In various embodiments, controller 102 and projection engine 104 are encased in a single casing body (not shown). In alternate embodiments, controller 102 may be packaged as an external unit, e.g. an adapter, to be mated/attached to projection engine 104.

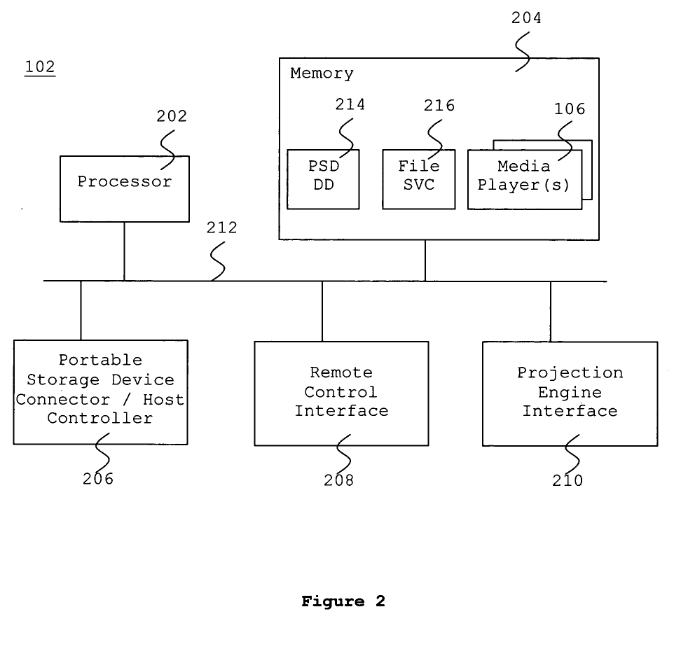

FIG. 2 illustrates controller 102 in further detail, in accordance with various embodiments. As illustrated, controller 102 includes processor 202, memory 204 coupled to each other via bus 212. Further, controller 102 includes portable storage device connector 206, remote control interface 208 and projection engine interface 210 coupled to earlier and the earlier described elements as shown. Memory 204 includes portable storage device (PSD) device driver (DD) 214, file services 216, and one or more media players 106.

As described earlier, in various embodiments, PSD connector 206 and PSD device driver 214 are USB connector/host controller, and USB device driver respectively. Further, remote control interface 208 is an IR receiver, and projection engine interface 210 is a conventional interface, e.g. an internal or external connector.

In various embodiments, file services 216 including file services for determining the file contents on portable storage device 108, including recognition of the file types, and reading the data blocks of media contents 110. In various embodiments, file services 216 support at least the bitmap, JPG, GIF, TIF and PCX file types. In alternate embodiments, file services 216 may provide other additional services.

In various embodiments, portable storage device (PSD) device driver (DD) 214, file services 216, and one or more media players 106 are implemented using a high level programming language, such as C. In alternate embodiments, they may be implemented using other high level programming languages, assembler and/or machine instructions.

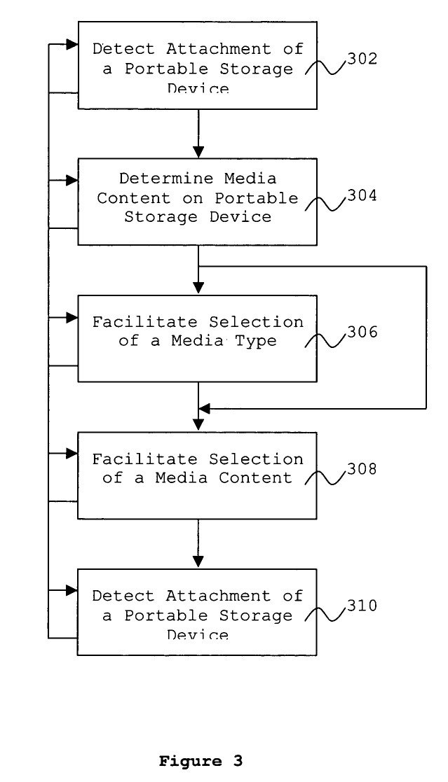

FIG. 3 illustrates a flow chart of selected operations of controller 102, in accordance with various embodiments. As illustrated, on power on/reset, controller 102 detects for attachment of a portable storage device 108, block 302. In various embodiments, this is accomplished by PSD DD 214 monitoring PSD connector 206 for the presence of a portable storage device 108, and on or after detection, notifies file service 216.

After detecting the presence of a portable storage device 108, controller 102 determines the media content 110 present in portable storage device 108, block 304. In various embodiments, this is accomplished by file service 216 reading the file directory of portable storage device 108, including the file type of each file present.

Then, for the embodiments, controller 102 facilitates a user in first selecting a media content type, block 306, and on selection of a media content type, a media content of the selected media content type, block 308, for rendering, i.e. projection. In various embodiments, if only one media content type is supported or present in portable storage device 108, controller 102 proceeds directly to block 308, skipping block 306.

On selection of the media content, controller 102 causes the content of the selected media content to be projected, block 310. The projection may be rendered under the control of the user provided using remote control 112, i.e. forward, backward, pause, stop, and so forth.

On completion of rendering/projecting of the selected media content, controller 102 may return the user to select another media content of the previously selected media content, block 308, or to select another media content type, block 306. The process may continue until the portable storage device 108 is detached. At such time, controller 102 returns to detecting for the attachment of another portable storage device 108, block 302.

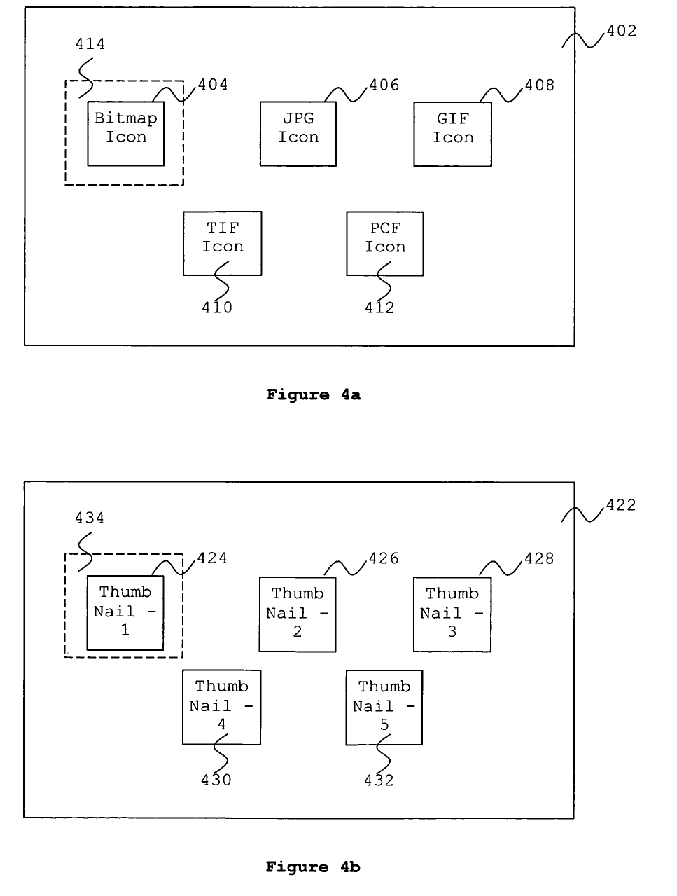

FIG. 4a illustrates an example projection 402, controller 102 may employ to facilitate a user in selecting a media content type, in accordance with various embodiments. For the embodiments, controller 402 causes a number of icons 404-412 to be projected, one for each of the media content type supported and present on a detected portable storage device 108. Additionally, for the embodiments, controller 402 causes an indicator 414, e.g. a highlighter, to highlight a current “in focus” media content type. The user may use remote control 112 to cause indicator 414 to be moved from one icon to another, changing the icon that is “in focus”, and eventually selecting the icon “in focus”, thereby selecting the media content type represented.

FIG. 4b illustrates an example projection 422, controller 102 may employ to facilitate a user in selecting a media content of a selected media content type, in accordance with various embodiments. For the embodiments, controller 402 causes a number of thumbnails 424-432 to be projected, one for each of the media content of the selected media content type. In various embodiments, the thumbnails are the corresponding first pages of the media content present, of the selected media content type. Additionally, for the embodiments, controller 402 causes an indicator 434, e.g. a highlighter, to highlight a current “in focus” media content. The user may use remote control 112 to cause indicator 434 to be moved from one thumbnail to another, changing the thumbnail that is “in focus”, and eventually selecting the thumbnail “in focus”, thereby selecting the media content represented.

Although specific embodiments have been illustrated and described herein, it will be appreciated by those of ordinary skill in the art that a wide variety of alternate and/or equivalent implementations may be substituted for the specific embodiments shown and described. This application is intended to cover any adaptations or variations of the embodiments discussed herein. Therefore, it is manifestly intended that this invention be limited only by the claims and the equivalents thereof.

What is claimed is:

1. In a projection apparatus, a method of operation, comprising:
detecting for attachment of a portable storage device to the projection apparatus;
detecting, after detection of an attachment, for presence of first one or more media assets of a first type in the portable storage device;
facilitating, after detection of presence of the first one or more media assets, selection of a first of the first one or more media assets of the first type for projection; and
projecting, after selection of the first media asset, the selected first media asset.

2. The method of claim 1, wherein said detecting for presence comprises detecting for presence in the portable storage device, one or more files of a selected one of a JPG type, a GIF type, a TIF type, a PCX type and a bitmap type.

3. The method of claim 1, wherein said facilitating comprises projecting for one or more of the detected first one or more media assets corresponding thumbnail(s).

4. The method of claim 3, wherein at least one thumbnail comprises a thumbnail of a first image of the corresponding media asset.

5. The method of claim 1, further comprising
detecting, after detection of an attachment, for presence of second one or more media assets of a second type in the portable storage device;
facilitating, after detection of presence of the second one or more media assets, selection of a second of the second one or more media assets of the second type for projection; and
projecting, after selection of the second media asset, the selected second media asset.

6. The method of claim 5, further comprising facilitating, after detection of presence of the first and second one or more media assets of the first and second types, selection of media asset(s) of one of the first and second types.

7. The method of claim 6, wherein said facilitating of the selection of media asset(s) of one of the first and second types comprises projecting first and second icons corresponding to media asset(s) of the first and second types.

8. A projection apparatus comprises:
a portable storage device attachment connector; and
a controller coupled to a projection engine and the portable storage device attachment connector, and adapted to cooperate with the projection engine and the portable storage device attachment connector, to
detect for attachment of a portable storage device to the portable device attachment connector,
detect, after detection of an attachment, for presence of first one or more media assets of a first type in the portable storage device,
facilitate, after detection of presence of the first one or more media assets, selection of a first of the first one or more media assets of the first type for projection. and
project, after selection of the first media asset, the selected first media asset.

9. The projection apparatus of claim 8, wherein said controller is adapted to cooperate with the portable storage device attachment connector to detect for presence in the portable storage device, one or more files of a selected one of a JPG type, a GIF type, a TIF type, a PCX type and a bitmap type, and the controller is further adapted to cooperate with the projection engine to project contents of a file of the selected type.

10. The projection apparatus of claim 9, wherein said controller comprises
a storage medium having stored therein first instructions implementing a file service and a device driver to cooperate with each other and the portable storage attachment connector to detect for attachment of a portable storage device, and second instructions implementing a player of media contents of the selected type, to cooperate with at least the file service and the projection engine to effectuate the projection of contents of a file of the selected type; and
a processor coupled to the storage medium to execute the first and second instructions.

11. The projection apparatus of claim 8, wherein the controller is adapted to include with said facilitating projection of corresponding thumbnail(s) for one or more of the detected first one or more media assets.

12. The projection apparatus of claim 8, wherein the controller is further adapted to
detect, after detection of an attachment, for presence of second one or more media assets of a second type in the portable storage device;
facilitate, after detection of presence of the second one or more media assets, selection of a second of the second one or more media assets of the second type for projection; and
project, after selection of the second media asset, the selected second media asset.

13. The projection apparatus of claim 12, wherein the controller is further adapted to facilitate, after detection of presence of the first and second one or more media assets of the first and second types, selection of media asset(s) of one of the first and second types.

14. The projection apparatus of claim 13, wherein the controller is further adapted to include with said facilitating of the selection of media asset(s) of one of the first and second types projection of first and second icons corresponding to media asset(s) of the first and second types.

15. The projection apparatus of claim 8, wherein the portable storage device attachment connector comprises a universal serial bus connector, and the apparatus projection apparatus further comprises a universal serial bus host controller coupling the controller to the universal serial bus connector.

16. The projection apparatus of claim 8, wherein the portable storage attachment connector is adapted to receive a non-volatile solid state portable storage device.

17. The projection apparatus of claim 8, wherein the projection apparatus further comprises an interface to couple the projection apparatus to the projection engine.

18. The projection apparatus of claim 8, wherein the projection apparatus further comprises the projection engine.

19. An apparatus comprises:
means for facilitating a portable storage device to be attached to the apparatus;
means for detecting attachment of a portable storage device to the apparatus, and presence of first one or more media assets of a first type in an attached portable storage device, the first one or more media assets having data of images; and
means for facilitating selection of a first of the first one or more media assets of the first type for projection.

20. The apparatus of claim 19, wherein the means for facilitating selection comprises means for causing projection of corresponding thumbnail(s) for one or more of the detected first one or more media assets.

21. The apparatus of claim 19, wherein
the means for detecting is further adapted to detect for presence of second one or more media assets of a second type in the portable storage device, the second one or more media assets also having data of images; and
the means for facilitating selection is further adapted to facilitate selection of a second of the second one or more media assets of the second type for projection.

22. The apparatus of claim 21, wherein the means for facilitating selection is further adapted to facilitate selection of media asset(s) of one of the first and second types.

23. The apparatus of claim 22, wherein the means for facilitating selection is further adapted to cause projection of first and second icons corresponding to media asset(s) of the first and second types.

24. The apparatus of claim 19, wherein the apparatus further comprises means for projecting images.
